(19) United States
(12) Patent Application Publication
(10) Pub. No.: US 2023/0412246 A1
(43) Pub. Date: Dec. 21, 2023

(54) ROBUST FRONT END SELECTION CONTROL

(71) Applicant: MediaTek Singapore Pte. Ltd., Singapore (SG)

(72) Inventors: Fei Xu, Beijing (CN); Wenze Qu, Beijing (CN); Yabo Li, San Jose, CA (US); Yaochao Liu, Beijing (CN); Wei-Jen Chen, HsinChu City (TW)

(21) Appl. No.: 17/821,420

(22) Filed: Aug. 22, 2022

(30) Foreign Application Priority Data
Jun. 20, 2022 (CN) CN 202210701093.5

(51) Int. Cl. H04B 7/08; H04B 17/21

(52) U.S. Cl. CPC H04B 7/088; H04B 17/21; H04W 88/02

(57) ABSTRACT

Apparatus and methods are provided for robust front end selection control. In one novel aspect, multi-stage head selection is provided. In one embodiment, the UE monitors one or more head-selection triggers, performs a UE Rx wide beam measurement to select at least one deactivated head as at least one standby head based on one or more coarse-beam selection criteria upon detecting at least one head-selection trigger, performs a UE Rx fine beam selection on the active head and the selected standby head, and switches the standby head as the active head based on a result of the fine Rx beam selection and head selection criteria. One or more operations are used for the multi-stage head selection, including multi-head operation, multi-CC measurement, and joint RRM and head selection operation.

### CROSS REFERENCE TO RELATED APPLICATIONS

This application claims priority under 35 U.S.C. § 119 from Chinese Application Number CN 202210701093.5 titled “ROBUST FRONT END SELECTION CONTROL,” filed on Jun. 20, 2022. The disclosure of each of the foregoing documents is incorporated herein by reference.

### TECHNICAL FIELD

The disclosed embodiments relate generally to wireless communication, and, more particularly, to robust front end selection control.

### BACKGROUND

5G radio access technology will be a key component of the modern access network. It will address high traffic growth and increasing demand for high-bandwidth connectivity. Advanced antenna developments make an advancement in end-user deployment in the 4G, 5G and future mobile networks. Further, end-user performance requirements continue to increase, putting high demands on the network to deliver increased coverage, capacity, and end-user throughput. The advanced antenna array in the user equipment (UE) enables state of the art beamforming and multiple input multiple output (MIMO) techniques that are powerful tools for improving end-user experience, capacity, and coverage. The antenna array in the UE significantly enhances network performance in both uplink and downlink. The wide adoption of the antenna array technology is made feasible by the technology advances in the integration of baseband, radio, and antenna, and a reduction in the digital processing cost of advanced beamforming and MIMO. When the UE is equipped with multiple panels of antenna arrays, selecting the best panel dynamically to achieve performance gains and cost efficiency in a specific network deployment is needed and robust front end selection control is required.

Improvements and enhancements are required for UE equipped with multi-panel/multi-head.

### SUMMARY

Apparatus and methods are provided for robust front end selection control. In one novel aspect, multi-stage RSRP/SNR measurement for head selection is provided. The multi-stage head selection includes coarse beam based RSRP/SNR measurements to select at least one standby head, and a fine beam based RSRP/SNR for final head selection. In one embodiment, the UE monitors one or more head-selection triggers, performs a UE Rx wide beam measurement to select at least one deactivated head as at least one standby head based on one or more coarse-beam selection criteria upon detecting at least one head-selection trigger, performs a UE Rx fine beam selection on the active head and the selected standby head, and switches the standby head as the active head based on a result of the fine Rx beam selection and head selection criteria. In other embodiments, one or more operations are used for the multi-stage head selection, including multi-head operation, multi-CC measurement, and joint RRM and head selection operation. In yet another embodiment, a beam pair link (BPL) procedure is performed for at least one head-selection steps comprising the UE Rx wide beam measurement for each active and deactivated head and the UE Rx fine beam selection for the active head and the standby head, wherein the BPL procedure builds one or more links between a UE head and a gNB Tx beam. In one embodiment, a periodicity of the head-monitor periodicity trigger is dynamically determined by one or more selection factors comprising SNR, loading rate, UE rotation speed, and UE moving speed. In another embodiment, a state machine to select optimal head for TRX is provided. It applies for different power class terminals. In one embodiment, the state machine includes a steady state, a monitoring state, and a transient state. In one embodiment, effective indicators correlated to head quality or TRX performance is used for hysteresis protection in the monitoring and/or transient state. In one embodiment, a difference of predefined resource quality is compared with a hysteresis threshold to determine whether to perform a head-selection state transition.

In another novel aspect, a procedure to build beam pair link (BPL) based on cross head RSRP/SNR measurement result is provided. The BPL implies the optimal head corresponds to each gNB beam. Cross head based RSRP/SNR measurement can be applied for coarse beam L1-RSRP, fine beam based L1-RSRP and L3-RSRP(RRM). A BPL assisted head selection method is provided to further integrate gNB TX beam selection and UE RX beam selection for better performance. In one embodiment, BPL procedure applies cross head based RSRP/SNR measurement. In another embodiment, upon detecting a TCI switch, a UE head linked a serving gNB beam is selected as the active head. In yet another embodiment, hysteresis protection mechanism applies to the BPL procedure.

In yet another novel aspect, a MIMO performance detection procedure is provided for head selection. The MIMO performance detection procedure detects MIMO performance degradation before or after a head switch and is used as a head-selection criterion. The MIMO performance detection procedure is based on one or more indicators comprising: physical downlink shared channel (PDSCH) demodulation reference signal (DMRS) MI, SNR, and channel state information reference signal (CSIRS) MI, uplink block error rate (BLER), and downlink BLER. In one embodiment, MIMO performance detection procedure is performed on the active head after the switching of the standby head to the active head, and wherein upon determining MIMO performance drops on the switched active head, a rollback is performed to switch to a previous active head.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary wireless network for robust front end selection control.

FIG. 2 illustrates diagrams of exemplary multi-head configurations and the top-level robust front end selection control procedures.

FIG. 3 illustrates an exemplary state transition diagram of the head-selection state machine.

FIG. 4 illustrates exemplary diagrams of dynamically determining the head-monitoring periodicity based on one or more periodicity triggers.

FIG. 5 illustrates exemplary diagrams of multi-head operation applies to the monitoring state and/or the transient state.

FIG. 6 illustrates exemplary diagrams of multi-CC operation applies to the monitoring state and/or the transient state.

FIG. 7 illustrates exemplary diagrams of joint-RRM operation applies to the monitoring state and/or the transient state.

FIG. 8 illustrates exemplary diagrams of BPL operation applies to the transient state.

FIG. 9A illustrates an exemplary flow diagram of the hysteresis mechanism for the wide beam measurement of the head-selection procedure.

FIG. 9B illustrates an exemplary flow diagram of the hysteresis mechanism for the fine beam selection of the head-selection procedure.

FIG. 10 illustrates exemplary diagrams for the MIMO performance detection procedure for the head-selection procedure.

FIG. 11 illustrates exemplary diagrams for event triggered head monitoring procedure for the head-selection procedure.

FIG. 12 illustrates an exemplary flow chart for the robust front-end selection control procedure.

### DETAILED DESCRIPTION

Reference will now be made in detail to some embodiments of the invention, examples of which are illustrated in the accompanying drawings.

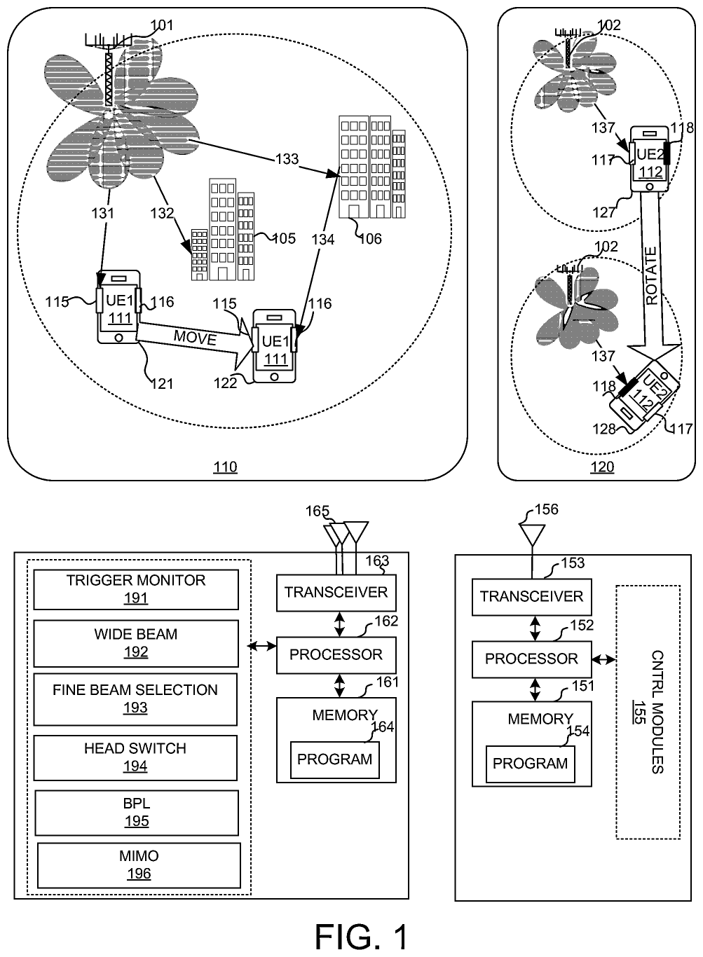

FIG. 1 is a schematic system diagram illustrating an exemplary wireless network for robust front end selection control according to embodiments of the invention. The exemplary wireless network could be a frequency range-2 (FR2) network. It applies to mmWave frequency range or above, e.g., T-Hz. A terminal is usually equipped with antenna array to make up for the large path loss typically in FR2 systems, and is equipped with multiple panels to deal with blocking effect for wireless propagation channels caused by rotation, hand, body, trees, or building, etc. Wireless systems 110 and 120 illustrate two exemplary scenarios for the front-end UE head selection. Wireless network 110 and 120 include one or more fixed base infrastructure units forming a network distributed over a geographical region. The base unit may also be referred to as an access point, an access terminal, a base station, a Node-B, an eNode-B (eNB), a gNB, or by other terminology used in the art. The network can be a homogeneous network or heterogeneous network, which can be deployed with the same frequency or different frequency. gNB 101 and gNB 102 are exemplary base stations in the wireless network.

Wireless networks 110 and 120 also include communication devices or mobile stations, such as UE1 111 and UE2 112. The mobile devices can establish one or more connections with one or more base stations. Both UE1 111 and UE2 112 are equipped with antenna array. These antenna arrays with possible different structures are arranged in different panels or heads. For example, UE1 111 has UE heads 115 and 116, and UE2 112 has UE heads 117 and 118. The UE with multiple heads/panels are configured with at least one active head, which performs transceiving (TRX). The other heads are deactivated/non-active heads.

In one example, UE1 111 at position 121 is connected to gNB 101 through radio wave 131 with UE head 115. UE1 111 moves to position 122. Building 105 blocks radio wave 132 and other radio wave from gNB 101 are blocked. Radio wave 133 reflected through building 106 and reached UE1 111 through radio wave 134 and is best received by UE head 116. In one novel aspect, UE1 111 implements robust front end head selection dynamically and will switch the active head from 115 to 116 after UE1 111 moves to position 122.

In another example, UE2 112 at position 127, equipped with UE heads 117 and 118, is connected with gNB 102 through radio wave 137 with UE head 117. As UE2 112 rotates to position 128, UE head 118 is better connected with radio wave 137. In one novel aspect, UE2 112 would trigger head selection to switch active head from UE head 117 to UE head 118.

Other scenarios, such as moving with distance, active head overheat, signal strength changes, would trigger the head selection procedure. In one novel aspect, the UE configured with head-selection trigger events. The UE monitors these trigger events and performs UE robust head selection procedure upon detecting one or more configured trigger events. The head selection procedure includes a UE receiving (Rx) wide/coarse beam measurement to select a standby head, followed by a UE Rx fine beam selection to select an active head. The UE performs head switching based on the head selection procedure. Optionally, hysteresis mechanism is implemented for at least one process of the UE Rx wide beam measurement and the UE Rx fine beam selection.

FIG. 1 further illustrates simplified block diagrams of a base station and a mobile device/UE for the robust front-end selection. gNB 101 has an antenna 156, which transmits and receives radio signals. An RF transceiver circuit 153, coupled with the antenna, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in gNB 101. Memory 151 stores program instructions and data 154 to control the operations of gNB 101. gNB 101 also includes a set of control modules 155 that carry out functional tasks to communicate with mobile stations.

UE1 111 has antenna array 165, which transmits and receives radio signals. An RF transceiver circuits 163, coupled with the antenna, receives RF signals from antenna 165, converts them to baseband signals, and sends them to processor 162. In one embodiment, the RF transceiver may comprise multiple RF modules (not shown). RF transceiver 163 also converts received baseband signals from processor 162, converts them to RF signals, and sends out to antenna 165. Processor 162 processes the received baseband signals and invokes different functional modules to perform features in the UE1 111. Memory 161 stores program instructions and data 164 to control the operations of the UE1 111. Antenna 165 sends uplink transmission and receives downlink transmissions to/from antenna 156 of gNB 101.

The UE also includes a set of control modules that carry out functional tasks. These control modules can be implemented by circuits, software, firmware, or a combination of them. A trigger monitor 191 monitors one or more head-selection triggers, wherein the plurality of UE RX heads includes at least one active head and one or more deactivated heads. A wide beam module 192 performs a UE receiving (Rx) wide beam measurement to select at least one deactivated head as at least one standby head based on one or more coarse-beam selection criteria upon detecting at least one head-selection trigger. A fine beam module 193 performs a UE Rx fine beam selection on the active head and the selected standby head. A head switch module 194 switches the standby head as the active head based on a result of the UE Rx fine beam selection and head selection criteria. A beam pair link (BPL) module 195 performs a BPL procedure for at least one head-selection steps comprising the UE Rx wide beam measurement for each active and deactivated head and the UE Rx fine beam selection for the active head and the standby head, wherein the BPL procedure builds one or more links between a UE head and a gNB Tx beam. A MIMO module 196 performs a MIMO performance detection procedure, wherein the head-selection criteria include results of the MIMO performance detection procedure.

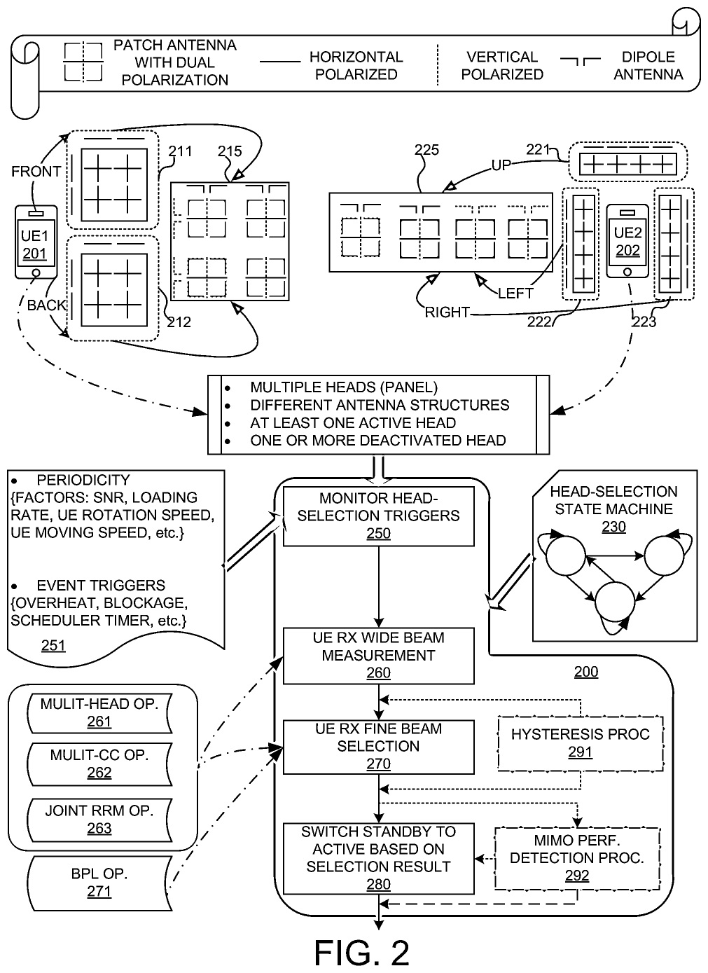

FIG. 2 illustrates diagrams of exemplary multi-head configurations and the top-level design of robust front end selection control procedures according to embodiments of the invention. On a terminal, total panel number, panel location, panel type and antenna structure are quite different based on user scenarios. A panel can also be called as ‘head’. Two exemplary multi-head configurations for UE1 201 and UE2 202 are presented. UE1 201 has two heads, a front side head 211 and a back side head 212. Front side head 211 and back side head 212 has multiple antennae as shown in 215, including four patch antennae of dual polarization, and four dipole antennae. Each patch antenna has one horizontal polarized and one vertical polarized, 1V+1H. Each UE head in this configuration, such UE head 211 and 212, has twelve antennae, (4P+2D)V+(4P+2D)H, which includes four patch antennae with vertical polarization, two dipole antennae with vertical polarization; and four patch antennae with horizontal polarization, two dipole antennae with horizontal polarization. In another exemplary multi-head configuration for UE2 202, three heads are used for UE2 202, including upside head 221, left-side head 222, and right-side head 223. UE head 221, 222, and 223 has multiple antennae as shown in 225, including four patch antennae and four dipole antennae. Panel 215 and 225 both has twelve antennae but with different arrangements. UE1 201 and UE2 202 shows exemplary configuration. The UE, when equipped with antenna array, can be configured with multiple heads/multiple panels. These UE heads can be configured with different antenna structures. In operation, at least one UE head is the active head, which performs transceiving radio signals. One or more UE heads are configured as deactivated UE heads. Usually the terminal/UE only needs to activate one head for TRX, and one or more other heads can be deactivated for power saving. When signal propagation condition changes, the terminal/UE need to adjust the active head dynamically to gain optimal TRX performance. Further other key performance indicators should also be considered in some embodiments, such as latency, stability and power consumption when selecting a head for TRX.

For a FR2 terminal/UE, a roust scheme is needed to select the best head for TRX and balance latency, stability, and power consumption. To select a proper head for TRX, regular measurements on all heads are necessary. In general, a head with strongest reference signal received power/signal noise ratio (RSRP/SNR) can be selected as active head to gain better MIMO performance. However, the head's MIMO performance is not always the best even with the strongest RSRP/SNR measurement result. Further, to reduce the latency of selecting the best head, it is expected that the regular measurement periodicity is as small as possible. However, too frequent measurement will cause too much power consumption. In some scenarios, such as, signal is weak or non-line-of-sight (NLOS) scenario, ping-pong effect may happen frequently while switching between different heads, which will cause serious TRX performance degradation. Proper procedures are required to minimize the ping-pong effect. Furthermore, power consumption of FR2 terminal is more critical than FR1 because antenna array is deployed, and it will significantly impact on user experience. To balance performance, latency, stability, and power consumption, different strategies are applied for different scenarios, e.g., rotation, moving, NLOS/LOS etc., which means reliable scenario detection mechanism is needed.

In one novel aspect, a robust head selection procedure 200 is implemented. At step 250, the UE monitors head-selection triggers. Head selection triggers can be dynamically configured, including exemplary triggers 251. Triggers 251 includes a head-monitor periodicity trigger, and one or more preconfigured event triggers. One or more factors are considered to determine the length of the head-monitor periodicity, including SNR, loading rate, UE rotation speed, UE moving speed, and head performance related factors. The event triggers include overheat condition of the active head, the active head is blocked, a scheduler timer expiry, performance drops after head switch, and head selection related events. At step 260, UE performs UE Rx wide beam measurements on all UE heads and selects at least one standby head from the deactivated heads based on one or more coarse-beam selection criteria. According to some embodiments, the one or more coarse-beam selection criteria comprises RSRP and SNR. At step 270, the UE performs UE Rx fine beam selection on the active head and the selected standby head. At step 280, the UE switches the standby head to be the active head based on a result of the fine Rx beam selection and head selection criteria. One of the head selection criteria is the head switch decision is based on RS (reference signal) quality, such RSRP/SNR or mutual information (MI), which is measured with UE fine beam. To select a UE head to optimize TRX performance, further procedures are implemented, including a multi-head operation 261, a multi-CC (component carrier) operation 262, a joint RRM (radio resource management) operation 263, and a RSRP/SNR-based beam pair link (BPL) operation 271. Operations 261, 262 and 263 apply to at least one procedure including the wide beam measurement procedure 260 and the fine beam selection procedure 270. Operation 271 applies to the fine beam selection procedure 270. Operations 261, 262, 263 and 271 can be used alone or be implemented together in any combinations. For example, for a fine beam selection on the active head and the standby head, both the multi-head operation and the multi-cc operation are used. In other embodiments, hysteresis procedure 291 is implemented for the wide beam measurement procedure 260 or the fine beam selection procedure 270, or both. MIMO performance detection procedure 292 is performed either before the switching procedure 280 or after the switching procedure 280.

In one novel aspect, one state transition diagram 230 for front-end selection is provided. The states comprise a steady sate, a monitor state, and a transit state. The UE monitors the one or more head-selection triggers in the steady state, performs the UE Rx wide beam measurement in the monitor state, and performs the UE Rx fine beam selection in the transient state.

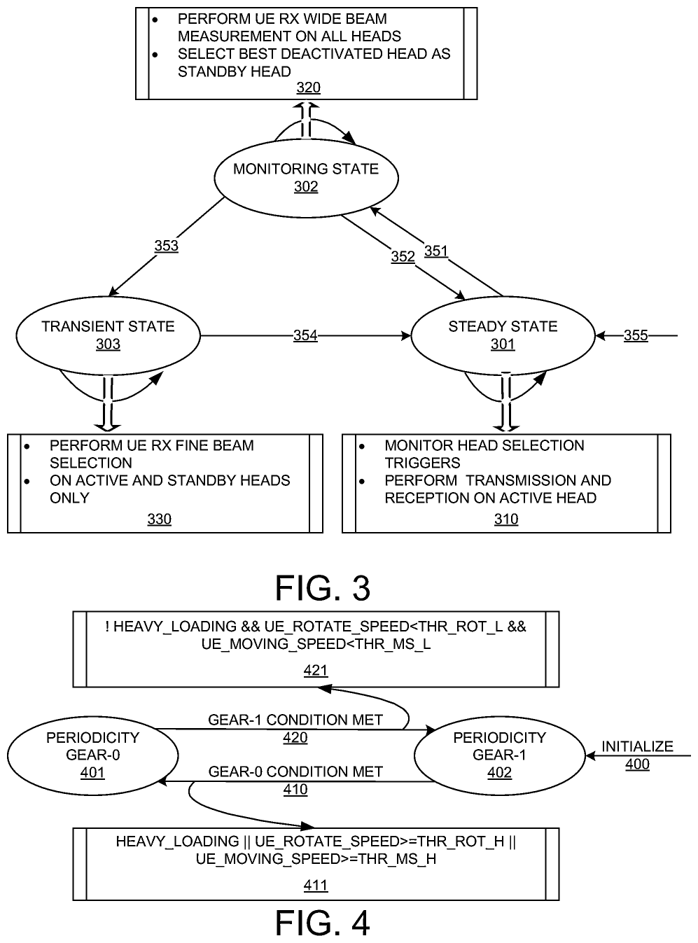

FIG. 3 illustrates an exemplary state transition diagram according to embodiments of the invention. A steady state 301, a monitoring state 302, and a transient state 303 are provided/configured. At step 355, the UE enters steady state 301 after the first cell (e.g., FR2 cell) is added. In steady state 301, at step 310, the UE performs signal transmission and reception on the active head. UE monitors head selection triggers. The head selection triggers include a head-monitor periodicity trigger, and one or more preconfigured event triggers. Upon detecting one or more head selection triggers, at step 351, the UE transitions from steady state 301 to monitoring state 302. At monitoring state 302, at step 320, the UE performs UE Rx wide beam measurements on all heads and selects one or more best deactivated head as the standby head. When the selected standby head is not better than the current active head, at step 351, the UE moves back to steady state 301. When one selected standby head is better than the active head, at step 353, the UE moves to transient state 303. At transient state 303, at step 330, the UE performs UE Rx fine beam selection on the active head and the selected standby head only. The UE in transient state 303, monitors one or more transient events and enters steady state 301 upon detecting the one or more transient events. One transient event occurs when joint L1-RSRP & head-selection is performed, and there is no solid head selection result until transient state expires. In this case, the UE enters the steady state. Another exemplary transient event occurs when most active gNB TX beams are more friendly in the standby head. The UE enters steady state 301 switching the standby head as the new active head.

TABLE 1
Exemplary transitioning procedures and triggering
conditions for the head-selection state transition

| CONDITION | SOURCE | TARGET | DESCRIPTION |
|---|---|---|---|
| When one of | Steady | Monitoring | Condition-1a |
| condition | state | state | Maintain a timer with periodicity length (e.g., |
| Contion-1a/ | | | 200 ms, 640 ms or 1280 ms). After this timer |
| Contion-1b/ | | | expires, reset, and enter monitoring state. |
| is true | | | Condition-1b |
| | | | After event is triggered (active head overheats, |
| | | | blockage cause link quality drop, or perf drop |
| | | | after head switch), enter monitoring state. |
| When | Monitoring | Transient | Conditon-2 |
| Condition-2 | state | state | When the HEAD-MON is completed, and the |
| is true | | | standby head (selected from non-active head) |
| | | | is better than active head. According to some |
| | | | embodiments, RSRP/SNR of standby head |
| | | | maybe checked again before head-switch. |
| When | Monitoring | Steady | Condition-3a |
| Condition-3a | state | state | When the HEAD-MON is completed, and the |
| is true | | | standby head is not better than active head. |
| | | | At this time, the original active head maybe |
| | | | used for TX/RX. |
| When one of | Transient | Steady | Condition-3b |
| Condition-3b/ | state | state | When joint L1-RSRP & head-selection is |
| Condition-3c | | | performed, and there is no solid head |
| is true | | | selection result until transient state expires, |
| | | | enter steady state. |
| | | | Condition-3c |
| | | | When most active gNB TX beams are more |
| | | | friendly in standby head, enter steady state |
| | | | right away. |

FIG. 4 illustrates exemplary diagrams of dynamically determining the head-monitoring periodicity based on one or more triggers according to embodiments of the invention. When the UE in the steady state, the timer with a head-monitoring periodicity triggers the UE moves to the monitoring state. To reduce latency in head selection, smaller head-monitoring periodicity is preferred. On the other hand, to reduce power consumption, larger head-monitoring periodicity is preferred. In one embodiment, the head-monitoring periodicity is configured dynamically based on preconfigured triggers. Smaller periodicity is applied when channel condition varies rapidly; Instead, larger periodicity is applied when channel condition is pretty good. In one exemplary configuration, the head-monitoring periodicity is configured with a periodicity gear-0 401 with smaller periodicities and a periodicity gear-1 402 with a larger periodicity. At step 400, upon a first FR2 cell is added, the UE is configured with periodicity gear-1 402. Upon detecting one or more conditions 411, the UE reconfigures the head-monitoring periodicity to gear-0 at step 410. Conditions 411 include, heavy loading is determining to be true, or UE rotation speed is greater than or equal to a preconfigured rotating threshold, or UE moving peed is greater than or equal to a preconfigured moving threshold. The UE, when configured with periodicity gear-0 401 monitors conditions 421 and reconfigures head-monitoring periodicity to gear-1 at step 420. Conditions 421 include heavy loading is determining to be false, and UE rotation speed is smaller than or equal to a preconfigured rotating threshold, and UE moving peed is smaller than or equal to a preconfigured moving threshold.

In one embodiment, the gear-0 is configured with different value based on the configuration of the active head. For example, gear-0 head-monitoring periodicity is configured to be 200 ms when multi-head can be monitored at the same time. gear-0 head-monitoring periodicity is configured to be 640 ms when head monitoring for different heads are performed in time division multiplex (TDM) manner. Gear-1 head-monitoring periodicity is configured to be 1280 ms.

TABLE 2
Head-monitoring periodicity exemplary configuration.

| | head monitoring | head monitoring | |
|---|---|---|---|
| | for different | for different | |
| | heads can be | heads are | |
| Gear | performed at the | performed in | Condition |
| Index | same time | TDM manner | to Enter |
| Gear-0 | 200 ms | 640 ms | Flag_heavy_loading == |
| | | | true, or |
| | | | ue_rotation_speed ≥ |
| | | | thr_rot_h, or |
| | | | ue_moving_speed ≥ |
| | | | thr_ms_h |

| | | |
|---|---|---|
| Gear-1 | 1280 ms | Flag_heavy_loading == |

false, and
ue_rotation_speed <
thr_rot_l, and
ue_moving_speed <
thr_ms_l

The ue_rotation_speed is the detected UE rotation speed and ue_moving_speed is the UE moving speed. thr_rot_h is a preconfigured rotation high threshold; and thr_rot_l is a preconfigured rotation low threshold. In one embodiment, thr_rot_h and thr_rot_l has the same value. thr_ms_h is a preconfigured moving speed high threshold; and thr_ms_l is a preconfigured moving speed low threshold. In one embodiment, thr_ms_h and thr_ms_l has the same value.

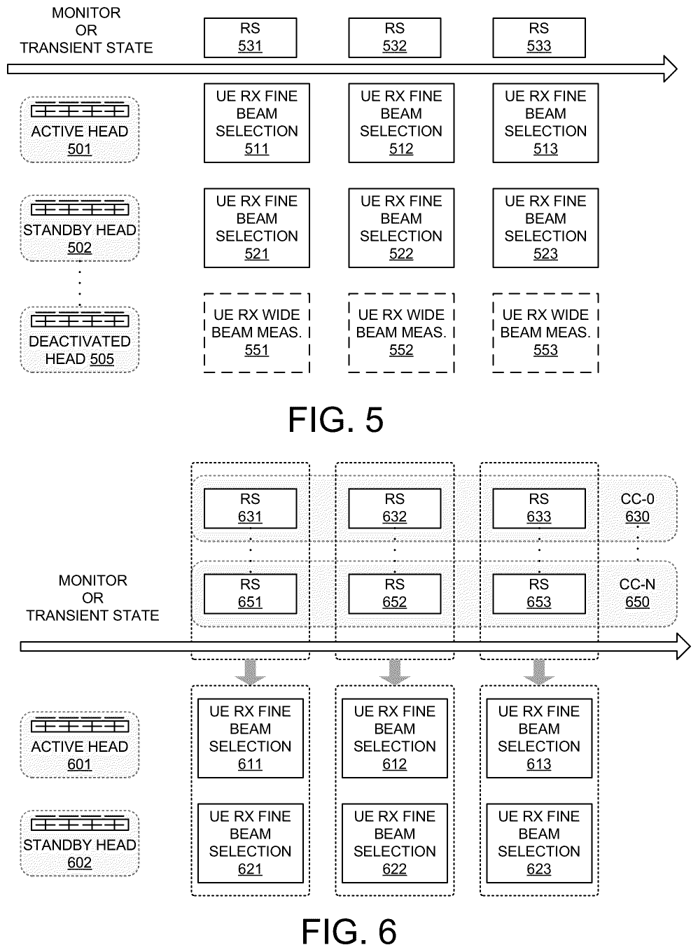

FIG. 5 illustrates exemplary diagrams of multi-head operation applies to the monitoring state and/or the transient state according to embodiments of the invention. To reduce latency of head selection, the UE performs multi-head operation to measure head quality simultaneously for speed up. Multi-head operation applies to both the wide beam measurement on all UE heads and the fine beam selection on the active head and the standby head. For example, the UE has an active head 501, a standby head 502 and one or more deactivated head/non-active head 505. Reference signals (RS) 531, 532, and 533 are configured by the network for measurements. The UE performs wide beam measurements on all heads, including the one or more deactivated head 505. The UE performs multi-head wide beam measurement on RS 531, 532, and 533, simultaneously on all UE heads. Together with the wide beam measurement of active head 501 and standby head 502, not shown, deactivated head 505 simultaneously performs the wide beam measurement on RS 531 at step 551, on 532 at step 552, and on 533 at step 553. All UE heads perform the wide beam measurement at the same time to speed up the head-selection process. Similarly, when in transient state, UE performs fine beam selection on both the active head 501 and the standby head 502 simultaneously for RS 531 at steps 511 and 521, respectively; for RS 532 at steps 512 and 522, respectively; and for RS 533 at steps 513 and 523, respectively. The multi-head operation can be performed simultaneously or time division multiplexing.

FIG. 6 illustrates exemplary diagrams of multi-CC operation applies to the monitoring state and/or the transient state according to embodiments of the invention. In many networks, multi-CC is configured. Multi-CC based RSRP/SNR measurement is applied to increase reliability of the head-selection result. The multi-CC operation applies to both the wide beam measurement on all UE heads in the monitoring state and the fine beam selection on the active heads and the standby head in the transient state. The UE is equipped with at least an active head 601 and a standby head 602. Multi-CC is configured with CC-0 630 to CC-N 650. CC-0 630 includes RS 631, RS 632, and RS 633. CC-N 650 includes RS 651, RS 652, and RS 653. At step 611, active head 601 performs fine beam selection on multiple CCs including RS 631 and RS 651. At step 621, standby beam 602 performs fine beam selection on multiple CCs including RS 631 and RS 651. Similarly, at step 612 active head 601 performs fine beam selection on multiple CCs including RS 632 and RS 652. At step 622, standby beam 602 performs fine beam selection on multiple CCs including RS 632 and RS 652. At step 613 active head 601 performs fine beam selection on multiple CCs including RS 633 and RS 653. At step 623, standby beam 602 performs fine beam selection on multiple CCs including RS 633 and RS 653. Multi-CC operation applies to wide beam measurement on all UE head in the similar way.

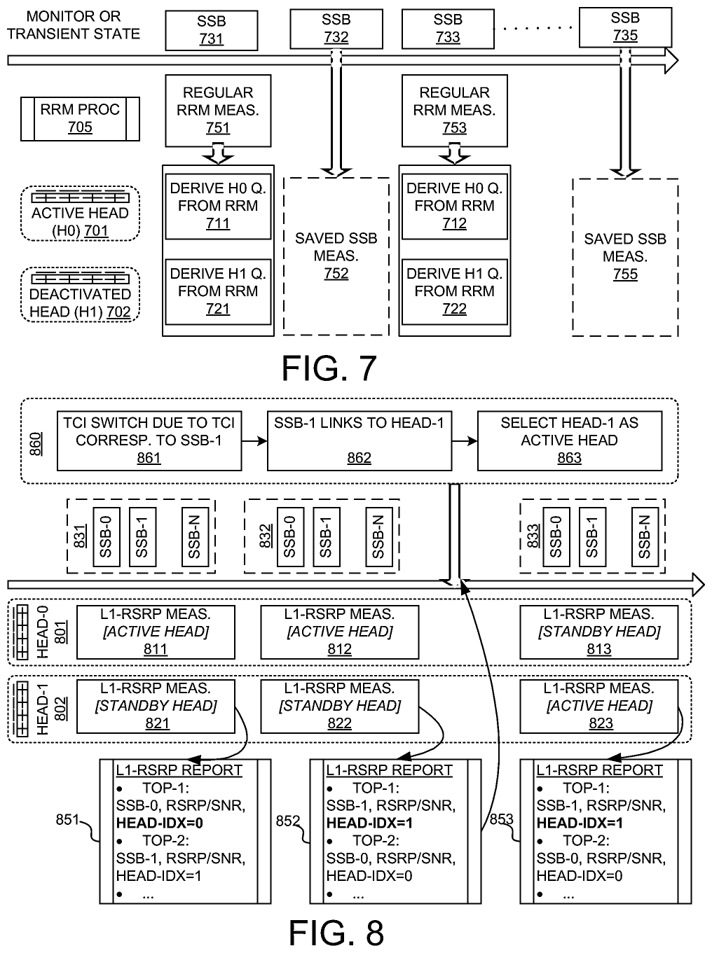

FIG. 7 illustrates exemplary diagrams of joint-RRM operation applies to the monitoring state and/or the transient state according to embodiments of the invention. The joint-RRM operation is an operation that joints RRM and head selection. It will be applied to reduce the consumed RS number. The joint-RRM operation applies to the wide beam measurement on all UE heads in the monitoring state. In other embodiments, the join-RRM operation may also be used in the fine beam selection on the active head(s) and the standby head(s) in the transient state. The UE is equipped with at least an active head 701 and a deactivated head 702. SSB 731, 732, 733, and 735 are configured. RRM measurement procedure 705 performs regular RRM measurement on SSB 731 and SSB 733 at steps 751 and 753, respectively. UE active head (H0) 701 and deactivated head (H1) 702 derives H0 and H1 qualities at steps 711 and 721, respectively, from the regular RRM measurement result of step 751 on SSB 731. Similarly, UE active head (H0) 701 and deactivated head (H1) 702 derives H0 and H1 qualities at steps 712 and 722, respectively, from the regular RRM measurement result of step 753 on SSB 733. With the joint-RRM operation, the measurement results on SSB 732 and SSB 735, respectively, are saved at step 752 and 755.

FIG. 8 illustrates exemplary diagrams of BPL operation applies to the transient state according to embodiments of the invention. In some embodiments, beam pair link (BPL) is built based on cross head RSRP/SNR measurement result. According to one embodiment, cross head RSRP/SNR measurement is performed on multiple heads, and the correspondence between gNB beam and head is determined based on the measurement result. The BPL implies the optimal head corresponds to each gNB beam. Cross head based RSRP/SNR measurement can be applied for coarse beam L1-RSRP, fine beam based L1-RSRP and L3-RSRP(RRM). A BPL assisted head selection method is provided to further integrate gNB TX beam selection and UE RX beam selection for better performance. In one embodiment, BPL procedure applies cross head based RSRP/SNR measurement based on L1-RSRP. In another embodiment, upon detecting a TCI switch, a UE head linked a serving gNB beam is selected as the active head. In yet another embodiment, hysteresis protection mechanism applies to the BPL procedure.

In one novel aspect, cross head based L1-RSRP measurement and report is applied to build a BPL. The BPL assisted head selection procedure is provided. The UE is equipped with at least a head-0 801 and a head-1 802. SSBs for L1-RSRP are configured with SSB-0, SSB-1, and SSB-N, at different times of exemplary SSBs 831, 832, and 833. In the current network, L1-RSRP are measured on the active and standby heads regularly, such as steps 811, 812, and 813 for head-0 801 and 821, 822, and 823 for head-1 802. The L1-RSRP measurement is performed simultaneously on both heads, H0 801 and H1 802. L1-RSRP report are generated based on the L1-RSRP measurements. L1-RSRP report 851, 852, and 853 are generated for L1-RSRP measurements for SSBs 831, 832 and 833, respectively. The L1-RSRP report includes SSB information and RSRP/SNR. In one novel aspect, head information is added to the RSRP/SNR table to generate/maintain a link between the gNB Tx beam and its corresponding UE head. The beam pair link (BPL) is created and maintained in the L1-RSRP report. In one example, the BPL includes an SSB index (SSB-IDX), RSRP/SNR, and the head index (HEAD-IDX). Exemplary L1-RSRP report with the BPL is illustrated in L1-RSRP report 851, 852 and 853, wherein the HEAD-IDX are included.

With the BPL created and maintained in the L1-RSRP, BPL based head selection procedure 860 is provided. At step 861, based on L1-RSRP report 852, the TCI switch happens, and the new TCI corresponds to SSB-1. At step 862, it is determined that the SSB-1 links to head-1802. At step 863, the UE selects head-1 802 as the active head based on the L1-RSRP with the BPL.

In some scenario when the coverage is weak or exist NLOS problems, the head selection procedure may encounter ping-pong issues when the head selection ping pong among different UE heads. It leads to serious TRX performance degradation and other problems. To avoid the ping pong problem, hysteresis mechanisms are introduced in the wide beam measurement procedure and/or the fine beam selection procedure.

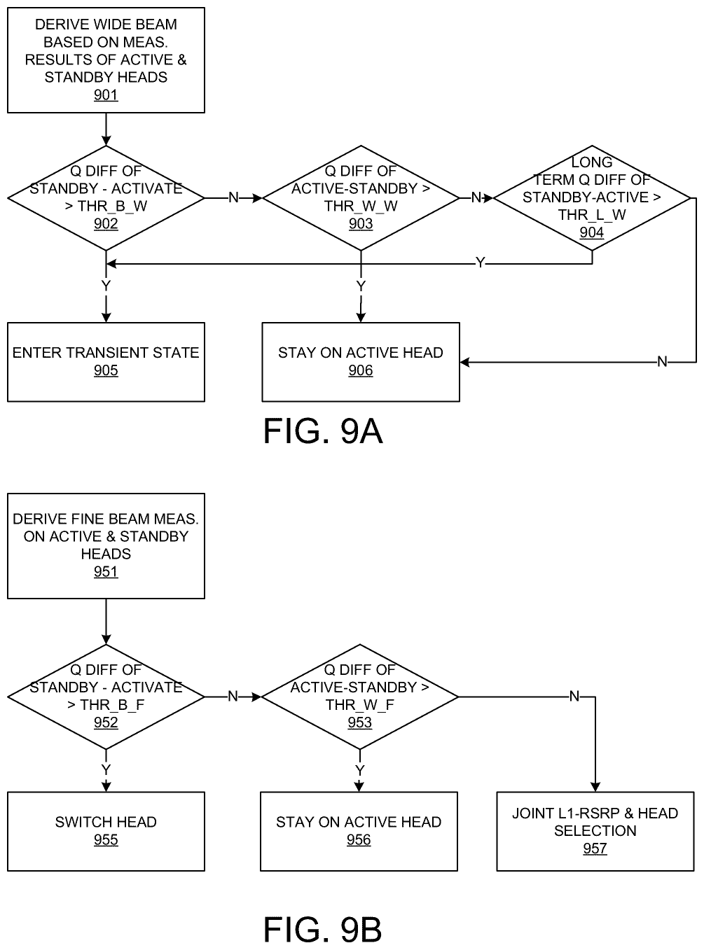

FIG. 9A illustrates an exemplary flow diagram of the hysteresis mechanism for the wide beam measurement of the head-selection procedure according to embodiments of the invention. At step 901, the UE derives wide beam measurements results including the active head and a selected standby head. At step 902, the UE determines if the quality difference between the selected standby head and the active head is obviously large. If the quality differences between the selected standby head and the active head is greater than a better-widebeam-threshold (thr_b_w), the UE determines at step 902 that the selected standby head is obviously better than the active head. The UE enters transient state at step 905, with the selected standby head. If step 902 determines no, the UE, moves to step 903. At step 903, the UE determines whether the quality of the standby head is obviously worse than the active head. In one embodiment, the UE determines the quality of the standby head is obviously worse than the active head when the quality difference of the active head and the standby head is greater than a preconfigured worse-widebeam-threshold (thr_w_w). If step 903 determines yes, the UE moves to step 906 and stays on the current active head. If step 903 determines no, the UE moves to step 904 and determines if the quality of standby head is long-term at least slightly better. In one embodiment, the UE determines the quality of standby head is long-term at least slightly better when UE determines the long-term quality difference of the standby head and the active head is greater than a longterm-widebeam-threshold (thr_l_w). If step 904 determines yes, the UE moves to step 905 and enters transient state to perform fine beam selection. If step 904 determines no, the UE moves to step 906 and stays on the active head.

FIG. 9B illustrates an exemplary flow diagram of the hysteresis mechanism for the fine beam selection of the head-selection procedure according to embodiments of the invention. At step 951, the UE derives fine beam measurement results on the active head and a selected standby head. At step 952, the UE determines if the quality difference between the selected standby head and the active head is obviously large. If the quality differences between the selected standby head and the active head is greater than a better-finebeam-threshold (thr_b_f), the UE determines at step 952 that the selected standby head is obviously better than the active head. The UE moves to step 955 and switches the standby head as the active head. If step 952 determines no, the UE, moves to step 953. At step 953, the UE determines whether the quality of the standby head is obviously worse than the active head. In one embodiment, the UE determines the quality of the standby head is obviously worse than the active head when the quality difference of the active head and the standby head is greater than a preconfigured worse-finebeam-threshold (thr_w_f). If step 953 determines yes, the UE moves to step 956 and stays on the current active head. If step 953 determines no, the UE moves to step 957 and performs the joint L1-RSRP and head selection procedure.

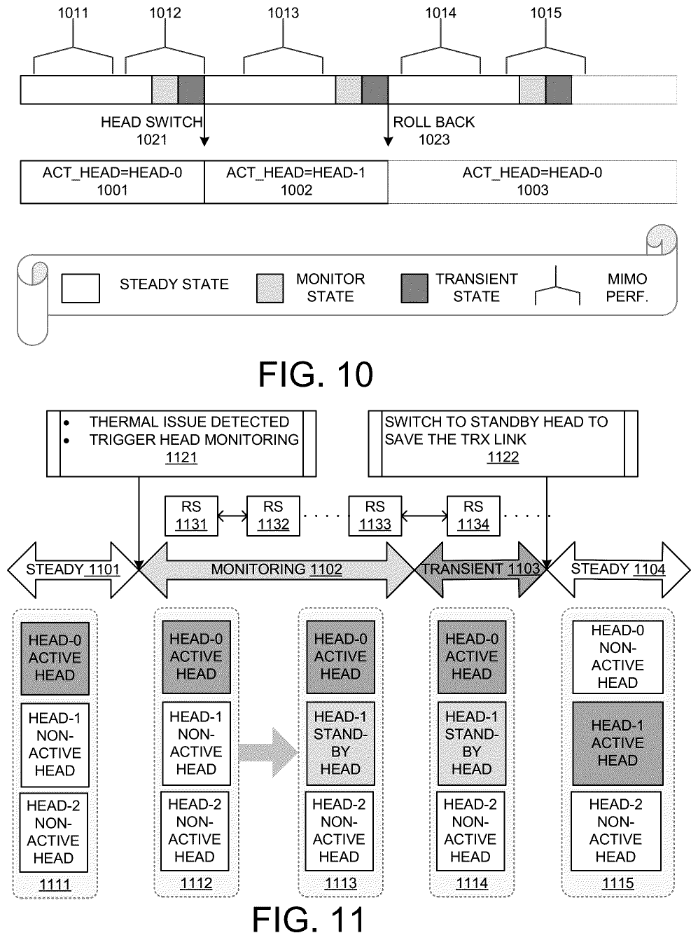

FIG. 10 illustrates exemplary diagrams for the MIMO performance detection procedure for the head-selection procedure according to embodiments of the invention. In one novel aspect, a MIMO performance detection procedure is performed and the results of it is a head-selection criterion. The MIMO performance detection procedure can be performed before the head switch or right after the head switch or both. The MIMO performance detection procedure is based on one or more indicators comprising: physical downlink shared channel (PDSCH) demodulation reference signal (DMRS) MI, SNR, and channel state information reference signal (CSIRS) MI, uplink block error rate (BLER), and downlink BLER. The MIMO performance detection procedure confirms the performance of the active head based on the one or more obtained indictors shown above. If the MIMO performance detection procedure detects performance drop happening after the switch, the UE will roll back to the previous active head. At step 1011 and 1012, MIMO performance detection procedure is performed. The UE calculates short-term BLER on the active head, Head-0. The UE at time period 1001 have Head-0 as the active head. At step 1021, head switch is performed. UE, at time period 1002, switches the active head to be Head-1. At step 1013, the UE performs MIMO performance detection procedure on the new active head, Head-1. As the step 1013 MIMO performance detection procedure detects MIMO performance degradation, the UE triggers rollback procedure by entering the monitoring state followed by transient state. At step 1023, the UE roll back to Head-0 as the active head. The UE in period 1003, rolls back to Head-0 as the active head. In another embodiment, the MIMO performance detection procedure is performed before the head switch and results of it is used as a criterion to decide whether to perform the head switch.

FIG. 11 illustrates exemplary diagrams for event triggered head monitoring procedure for the head-selection procedure according to embodiments of the invention. The UE stays in steady state can trigger a head-selection procedure when one or more preconfigured head monitoring trigger events are detected. In some cases, head selection is triggered by event to save the deteriorated TRX performance. One of the trigger events is the active head being overheated or blocked. At period 1101, the UE is in the steady state 1111 with head-0 as the active head and head-1 and head-2 as the non-active/deactivated heads. At step 1121, the UE detects thermal issue of the active head, head-0. For example, head-0 is detected to be overheating and head-1 and head-2 are determined to be with normal temperature. The head monitoring is triggered. The UE enters monitoring state in period 1102. RSs 1131, 1132, 1133, and 1134 in the monitoring and transient state are references for measuring the quality of the UE heads. In initial monitoring state 1112, UE performs wide beam measurements on all heads, including head-1 and head-2 while the overheated head-0 is still active head. Based on the wide beam measurement results in monitoring state 1113, the UE selects head-1 as the standby head, head-2 remains non-active head. At period 1103, with the standby head selected, the UE enters transient state. In transient state 1114, the UE performs fine beam selection on the standby head, head-1. At step 1122, upon determines the quality of the standby head, head-1 is good, the UE switches its active head to the standby head, head-1. In one embodiment, the UE determines the quality of the standby head is good when the quality of the standby head is greater than a preconfigured good quality threshold. In period 1104, the UE enters steady state. In steady state 1115, the UE has head-1 as the active head, the overheated head-0 is non-active/deactivated head. Head-2 remains the non-active/deactivated head. Similar procedures apply to other configured head monitoring trigger events.

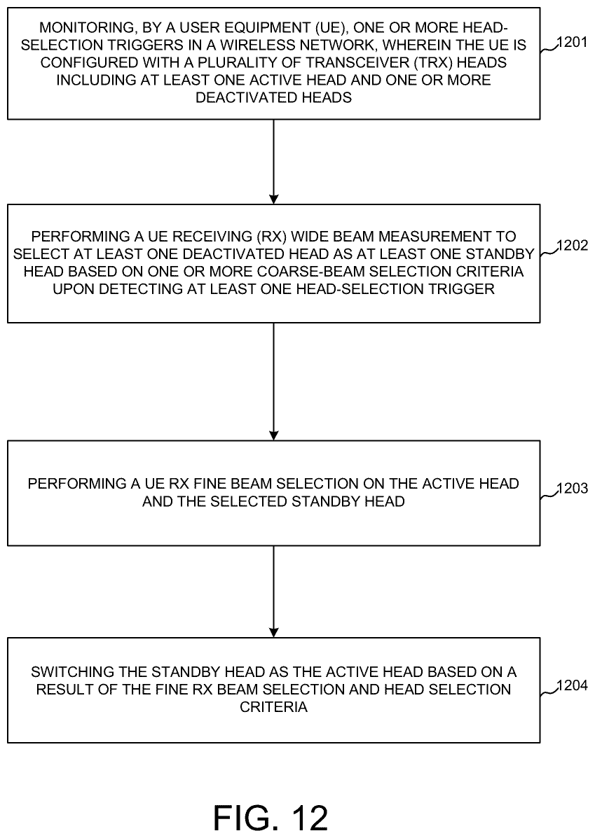

FIG. 12 illustrates an exemplary flow chart for the front-end selection control procedure according to embodiments of the invention. At step 1201, the UE monitors one or more head-selection triggers in a wireless network, wherein the UE is configured with a plurality of receiving heads including at least one active head and one or more deactivated heads. At step 1202, the UE performs a UE receiving (Rx) wide beam measurement to select at least one deactivated head as at least one standby head based on one or more coarse-beam selection criteria upon detecting at least one head-selection trigger. At step 1203, the UE performs a UE Rx fine beam selection on the active head and the selected standby head. At step 1204, the UE switches the standby head as the active head based on a result of the fine Rx beam selection and head selection criteria.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
monitoring, by a user equipment (UE), one or more head-selection triggers in a wireless network, wherein the UE is configured with a plurality of receiving (Rx) heads including at least one active head and one or more deactivated heads;
performing a UE Rx wide beam measurement to select at least one deactivated head as at least one standby head based on one or more coarse-beam selection criteria upon detecting at least one head-selection trigger;
performing a UE Rx fine beam selection on the active head and the selected standby head; and
switching the standby head as the active head based on a result of the fine Rx beam selection and head selection criteria.

2. The method of claim 1, wherein a multi-head operation is used for at least one of head-selection steps comprising the UE Rx wide beam measurement and the UE Rx fine beam selection, and wherein the multi-head operation is a simultaneous operation of multiple heads or a time division multiplexing operation.

3. The method of claim 1, wherein multiple carrier components (CC) measurement is performed for at least one head-selection steps comprising the UE Rx wide beam measurement for each active and deactivated head and the UE Rx fine beam selection for the active head and the standby head.

4. The method of claim 1, wherein results of radio resource management (RRM) measurements are used for at least one head-selection steps comprising the UE Rx wide beam measurement for each active and deactivated head and the UE Rx fine beam selection for the active head and the standby head.

5. The method of claim 1, wherein the one or more coarse-beam selection criteria comprises reference signal received power (RSRP), and signal to noise ratio (SNR), and wherein the head selection criteria include RSRP, SNR, or mutual information (MI) measured with UE fine beam.

6. The method of claim 1, wherein the head-selection triggers comprising a head-monitor periodicity trigger, and one or more preconfigured event triggers.

7. The method of claim 6, wherein a periodicity of the head-monitor periodicity trigger is dynamically determined by one or more factors comprising SNR, loading rate, UE rotation speed, and UE moving speed.

8. The method of claim 6, wherein the one or more preconfigured event triggers comprises overheat condition of the active head, the active head is blocked, performance drops after head switch, and a scheduler timer expiry.

9. The method of claim 1, wherein a steady sate, a monitor state, and a transit state are configured for head selection, and wherein the UE monitors the head-selection triggers in the steady state, performs the UE Rx wide beam measurement in the monitor state, and performs the UE Rx fine beam selection in the transient state.

10. The method of claim 9, wherein the UE performs hysteresis procedures in at least one head-selection state including the monitor state and the transient state, wherein a difference of head quality is compared with a hysteresis threshold to determine whether to perform a head-selection state transition.

11. The method of claim 1, further comprising: performing a beam pair link (BPL) procedure, wherein the BPL procedure builds one or more links between a UE head and a gNB Tx beam.

12. The method of claim 11, wherein the BPL procedure applies cross head based RSRP/SNR measurement based on L1-RSRP.

13. The method of claim 11, wherein the BPL procedure adds head information into RSRP/SNR table to maintain one or more links between gNB Tx beam and its corresponding UE head.

14. The method of claim 1, further comprising:
performing a MIMO performance detection procedure, wherein the head-selection criteria include results of the MIMO performance procedure.

15. The method of claim 14, wherein the MIMO performance detection procedure is based on one or more indicators comprising: physical downlink shared channel (PDSCH) demodulation reference signal (DMRS) MI, SNR, and channel state information reference signal (CSIRS) MI, uplink block error rate (BLER), and downlink BLER.

16. A user equipment (UE), comprising:
a plurality of receiving (Rx) heads that receive radio frequency (RF) signal in a wireless network;
a trigger monitor that monitors one or more head-selection triggers, wherein the plurality of Rx heads include at least one active head and one or more deactivated heads;
a wide beam module that performs a UE Rx wide beam measurement to select at least one deactivated head as at least one standby head based on one or more coarse-beam selection criteria upon detecting at least one head-selection trigger;
a fine beam module that performs a UE Rx fine beam selection on the active head and the selected standby head; and
a head switch module that switches the standby head as the active head based on a result of the fine Rx beam selection and head selection criteria.

17. The UE of claim 16, further comprises a beam pair link (BPL) module that performs a procedure for at least one head-selection steps comprising the UE Rx wide beam measurement for each active and deactivated head and the UE Rx fine beam selection for the active head and the standby head, wherein the BPL procedure builds one or more links between a UE head and a gNB Tx beam

18. The UE of claim 16, further comprises a MIMO module that performs a MIMO performance detection procedure, wherein the head-selection criteria include results of the MIMO performance procedure.

19. The UE of claim 16, wherein a steady sate, a monitor state, and a transit state are provided for head selection, and wherein the UE monitors the head-selection triggers in the steady state, performs the UE Rx wide beam measurement in the monitor state, and performs the UE Rx fine beam selection in the transient state.
